(19) United States
(12) Patent Application Publication
(10) Pub. No.: US 2008/0271357 A1
(43) Pub. Date: Nov. 6, 2008

(54) Fishing system with remote control and method of use

(76) Inventor: Donald L. Easterby, Cypress, CA (US)

Correspondence Address: FULWIDER PATTON LLP, 6060 CENTER DRIVE, 10TH FLOOR, LOS ANGELES, CA, 90045, US

(21) Appl. No.: 11/799,309

(22) Filed: May 1, 2007

(51) Int. Cl. A01K 97/00; A63H 23/04; A01K 91/02

(52) U.S. Cl. 43/26.1; 43/4

(57) ABSTRACT

A gripper on a miniature remote controlled boat constructed with an integral, soft core and release finger formed with a slit to frictionally receive a fish line from a rod.

### BACKGROUND OF THE INVENTION

1. Field of the Invention

The present invention relates to a fishing system.

2. Description of the Prior Art

The art of fishing has evolved from the necessity of food gathering to the sport of fly angling. Often times it is the fisherman with the most advanced fishing equipment who excels at the sport.

As any experienced fisherman will relate, it always seems that the larger and more abundant fish lie in an area distant from the fisherman or often times in water inaccessible by a passenger carrying floatation devices. The need has thus been recognized for smaller, miniature remote control boats to access those areas as by bodily carrying bobbins of deployable fishing lines into the remote areas to be deployed or possibly even just dragging a section of line from a fishing rod to a remote location as the fisherman maneuvers the deployment vessel by remote control. Certain species of fish are particularly sensitive to artificial lures, such as spinners, flies and fishing plugs and will quickly spook at any unnatural movement or shifting thereof which might suggest danger for the fish.

Examples of remote controlled floatation devices for carrying fishing lines with lures attached are shown in U.S. Pat. Nos. 3,739,516 issued Jun. 19, 1973; 3,710,500 issued Jan. 16, 1973; 3,911,609 issued Oct. 14, 1975; 4,161,077 issued Jul. 17, 1979; 4,339,888 issued Jul. 20, 1982; 4,635,391 issued Jan. 13, 1987; and U.S. Pat. No. 7,055,280 issued Jun. 6, 2006. Such devices suffer the shortcoming that the holding devices for releasably holding the line on the floatation members are often times of complex and expensive construction and frequently require some degree of force applied to the lure in order to effectuate release thus presenting a signal to the wary fish that something is awry.

Other efforts have led to a proposal that a miniature boat with an upright antenna carrying from the distal end of a metallic rotary bearing mounting an alligator type clip, spring loaded to grip between the jaws thereof a fishing line. A device of this type is shown in U.S. Pat. No. 4,161,077 to Ciaccio. Such devices while recognizing the need for remote controlled miniature vessels to deploy fishing line, suffer the shortcoming at such rotatable clips are relatively expensive, heavy, cumbersome and typically require a relatively high magnitude spring closure force on the jaws in order to securely hold the line until such time as the fish strikes. This high magnitude holding force tends to resist release of the line thus alerting the otherwise unsuspecting fish that the lure is not free floating in nature and poses danger to the fishes own well being.

### SUMMARY OF THE INVENTION

The fishing system of the present invention is characterized by a remote controlled miniature boat carrying a fish line gripper configured with an integral body of soft material and configured with a core and finger separated by a slit to frictionally hold the fishing line as the boat is deployed to a remote fishing area and until such time as the fisherman jerks on the line to free such line to allow the fisherman manipulating the line to play the lure in a customary technique to better the odds of attracting a fish.

In one embodiment, a controller is removably mounted to the fishing rod to facilitate manipulation of the controller by the fisherman.

The gripper may be constructed from a mat of rubber closed cell foam cut to a desired shape to form a circularly shaped core and spirally extending finger cooperating together to form the slip.

Other features and advantages of the invention will become apparent from the following detailed description, taken in conjunction with the accompanying drawings which illustrate, by way of example, the features of the invention.

### BRIEF DESCRIPTION OF THE DRAWINGS

FIG. 1 is a perspective view of a remote control fishing system embodying the present invention;

FIG. 2 is a side elevational view, partially broken away, of a miniature remote control boat included in the system shown in FIG. 1;

FIG. 3 is an enlarged detail view taken from the circle 3 of FIG. 2;

FIG. 4 is a partial side view of the miniature boat shown in FIG. 2 but with the included wand deflected by the strike a fish;

FIG. 5 is an enlarged detailed view taken from the circle 5 in FIG. 3;

FIG. 6 is a sectional view taken along the lines of 6-6 of FIG. 5;

FIG. 7 is a perspective view of fishing rod and remote control apparatus included in the system shown in FIG. 1;

FIG. 8 is a partial side view, in enlarged scale, of the rod and control apparatus shown in FIG. 7;

FIG. 9 is a vertical sectional view, in enlarged scale, taken from the line of 9-9 of FIG. 8; and

FIG. 10 is a perspective view of a fisherman, in enlarged scale, manipulating the rod and remote control apparatus shown in FIG. 7.

### DETAILED DESCRIPTION OF THE PREFERRED EMBODIMENTS

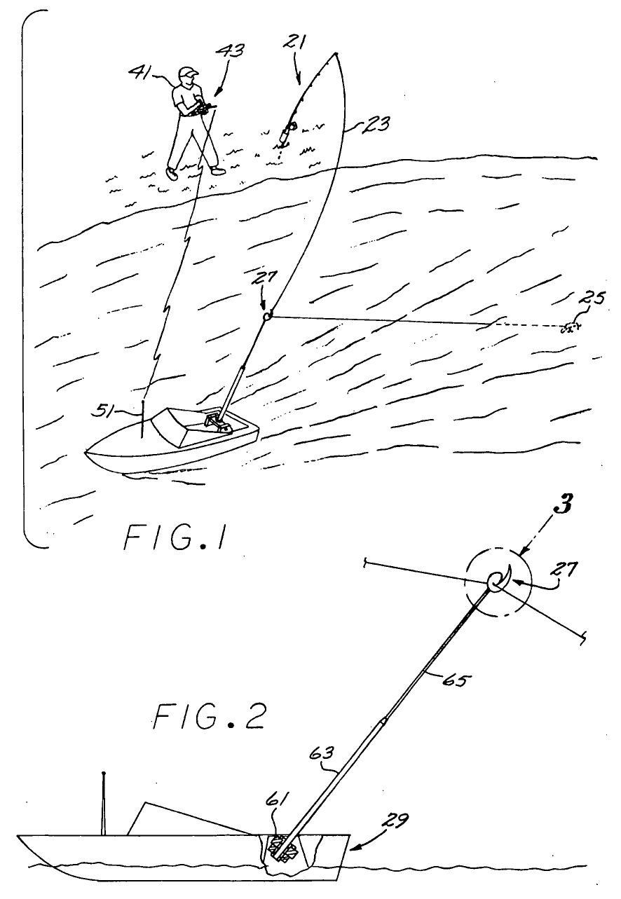

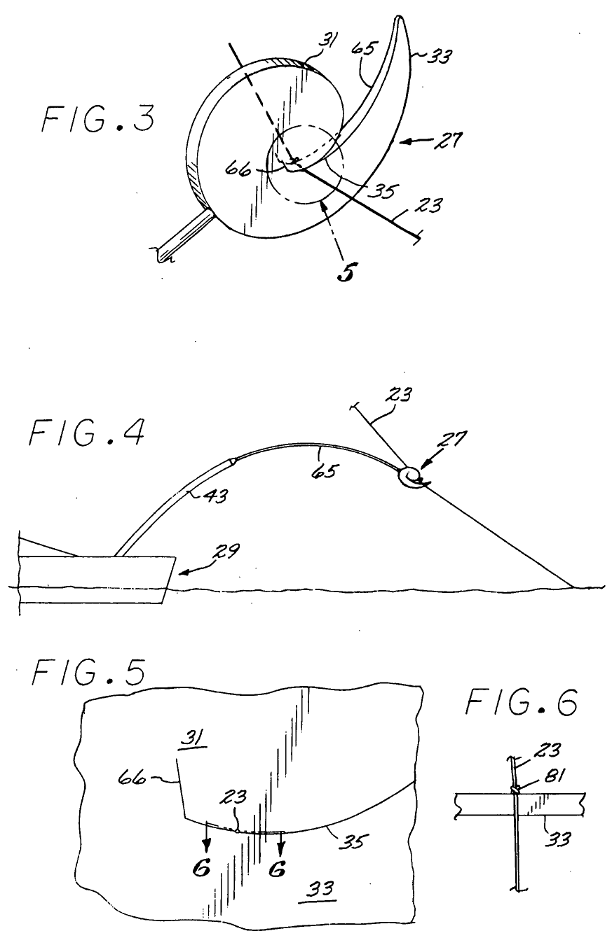

Referring to FIGS. 1, 2 and 3, the remote control fishing system of the present invention includes, generally, a fishing rod 21 for storing a fishing line 23 having a fishing jig or lure 25 on the end thereof and frictionally retained medially in a gripper 27 carried from a remote controlled miniature boat 29. Referring particularly to FIG. 3, the gripper 27 is of integral construction, typically cut from a mat of closed pore foam and having a body constructed of a core 31 having a flexible release finger 33 extending spirally therefrom and cooperating therewith to form a slit 35 frictionally retaining the medial section of the fishing line 23. Consequently, the fisherman 41 may conveniently attach the fishing line 23 medially in the slit 35 of the gripper 27 and by operating a remote control, generally designated 43, manipulate the miniature boat 29 away from shore or into a relatively inaccessible area to draw the lure 25 to the desired location. The fisherman may then give the rod a sharp jerk to release the line from the slit 35 to allow the angler to play the lure in a conventional manner.

Referring to FIG. 3, the gripper 27, in one preferred embodiment, is formed with a body having a major diameter of about 1⅜″ inches and a minor diameter of 1¼″ inches. The finger 33 is formed to project from the core 31 in contacting relationship along about ¼″ inch of the circumference and to project cantileverally there beyond for about ¾″ of inch in crescent fashion. The results of the construction provides the release finger 33 with the interior contact surface 65 that acts somewhat of a funnel to, during loading of the line 23 to funnel such line into the slit 35. When the fisherman desires he or she can apply a sharp jerk to the line 23 to draw it outwardly from the slit 35 along the surface 65 acting to deflect the free extremity of the finger 33 downwardly away from the core 31 to open the slit 35 and cooperate in release of the line for free play of the lure by the fisherman manning the rod 21.

As is recognized by many skilled fishermen, the larger and more abundant fish often locate themselves some distance from easily accessible fishing locations, as away from the shore line where the fisherman might be located, or in some instances, in shallow waters infested with sunken logs and often times seaweed, lily pads and the like. It is beneficial to have the capability to maneuver a lure some distance away from the land bound fisherman or, even away from a passenger boat to access distant fishing beds and the like.

It is a characteristic of many of the most desirable sport fish that they are acutely aware of the artificial bait seeking to lure them into striking and are quick to spit the lure out should any unnatural forces or movements be detected as the lure is struck. In this regard, it is desirable that the line deploying the lure be relatively free with only the slightest resistance applied to maintain the line suspended from the remote control boat for quick release thereof and the fish strikes to thus avoid detection and allowing the fisherman to possibly payout more line to encourage the fish to fully take the bait without detection from resistance in the line itself.

Fishing enthusiasts are often highly discriminating in selecting the desired fishing tackle, tackle which presents the optimum flex and resistance to the fish as initial contact is made with the lure to minimize detection and allow for play out of the line but to allow for setting of the hook and the play of the fish to apply resistance, resistances which is sometimes yielding and without abrupt breaking to thereby avoid snapping of a relatively fine fishing line while the fish is played to tire and allow retrieval to the fishing net (not shown). It is an object of one of the embodiments of the system of the present invention to allow the fisherman to employ the fishing rod 21 having his or her own particular characteristics of these actions.

The miniature boat 29 includes the usual propeller and rudder which is controlled by an onboard power and steerage system receiving signals through an antenna 51 of a receiver providing the controls and for varying the speed at direction of travel.

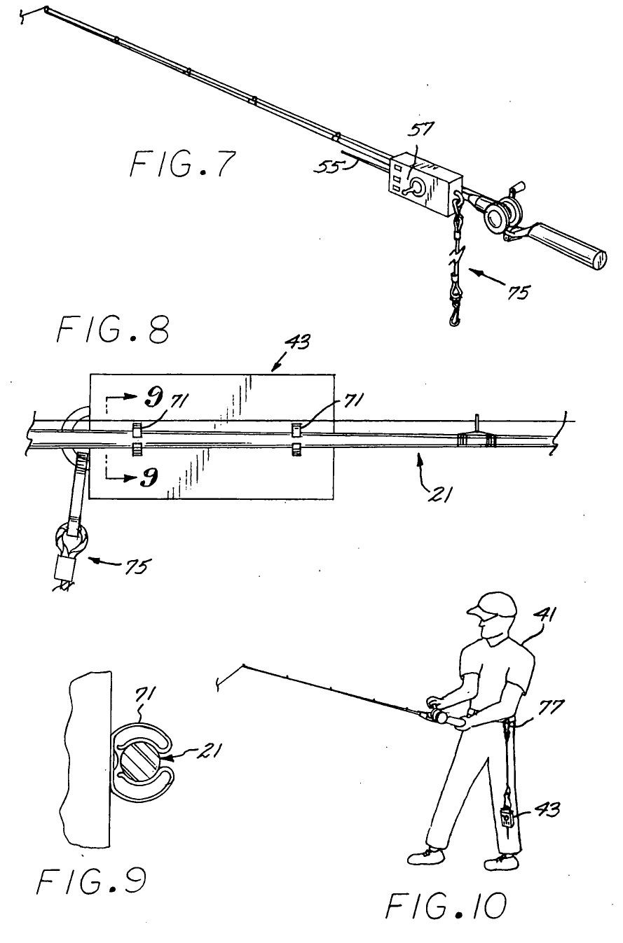

In one embodiment, the remote control device 43 includes a transmitter having an antenna 55 (FIG. 7) and controls 57 for hand manipulation to control speed and direction.

The boat 29 includes a small hull which may be on the order of 15 to 20 or 30 inches in length or even longer for heavier waters and includes a mounting device 61 constructed of a compression nut and washer which mounts a base rod 63 having a relatively stiff spring rate to resist flexing and itself mounts on the distal extremity thereof a more flexible wand 65. The wand may be constructed of temper spring steel and may have a diameter from 0.010 to 0.025 up to about 0.047 or larger diameter but with a preferred diameter of about 0.035 inches. In one preferred embodiment the base rod is about 6 inches in length and the wand about 16 inches in length to afford a significant degree of flexibility for the wand to be bent downwardly to the release position shown in FIG. 4 to present the slit parallel to the direction the fish is pulling the line.

The gripper 27 may be constructed of any type of resilient material such as soft foam, rubber, neoprene, or the like to provide for a substantial degree of flexibility and may be on the order of 1/16^{th} of the inch thick. In a preferred embodiment, the core 31 is of generally spirally circular shape and the body is configured with the crescent shaped finger 33 projecting spirally outwardly in cantilever fashion to form along the interior curved surface thereof a guide surface 65 along which the fishing line 23 might be drawn when a fish strikes to thereby tend to flex the release finger 33 away from the core 31 opening the slit 35 for free release of such line. In the preferred embodiment, the slit 35 curves inwardly and is formed with a laterally projecting catch leg 66 cooperating with the main body of the curve to define a dog leg shape so the line can be slid there into to be held in place during transport to the desired fishing spot. The wand 65 may be formed with a sharp point which may be stabbed into the body of such gripper and bounded in place.

In the embodiments shown in FIG. 7-10, the remote control 43 mounts on the back side of its housing a pair of resilient semi-circularly shaped spring clips 71 configured to be received in gripping relationship over the base of the fishing rod 21 to removably mount the control device thereon.

A snap tether, generally designated 75 may be connected to one end of the control housing for conveniently tethering the remote control 43 to the fisherman's belt 77 (FIG. 10).

In operation, it will be appreciated that the size, power and configuration of the miniature boat 29 will be selected in accordance with the particular fishing venue, it being recognized that for sea going or fishing in more rapid waters, a larger and more powerful miniature boat might be desirable. Likewise, the particular soft foam, plastic or neoprene selected for the gripper 27 will be dictated by the forces expected to be applied to the fishing line during the trolling and fishing stage prior to the time the line is released, either by a fish strike or a sharp jerk from the fishing rod. In calmer water conditions and fishing species which might quickly detect any major degree of resistance to release of the lure when the initial strike takes place, the gripper 27 will be selected and configured to frictionally retain the fishing line until such time as the fisherman jerks on the rod to apply a predetermined force in excess of about ¼ lb to the fishing line thus drawing the tip of the wand down while flexing the body of the gripper to draw the line from the catch slit 66 and apply force to the release finger 33 to flex it parallel to the direction of the line tending to draw the taught line along the surface 65 of the finger 33 to essentially hinge it about its base moving it away from the core tending to open the slit 35 to free the line for release. Since the gripper is constructed of soft, flexible material, the forces involved are relatively minor thus requiring only a relatively light jerk and minimal disturbance which might alert the fish that things are not well.

In any event, a fisherman may conveniently support the fishing rod 21 from any support well known in the art as depicted in FIG. 1. To load the gripper 27 he or she may grasp the body 31 of such gripper and slide the intermediate portion of the fishing line 23 the slit 35 to be slid laterally into the catch slit 66 to be held frictionally in place. In some instances, the fisherman may want the fishing line to slowly deploy out through the slit 35 as the boat 29 is maneuvered slowly from shore or into the fish bed. To facilitate this action, the fisherman may tie a knot 81 into the fishing line spaced back a distance, as for instance 20 feet from the lure 25. The fishing line 21 may be conveniently be initially positioned in the gripper with the lure 25 projecting about 8-10 feet from the gripper to be drawn through the water as the control 43 is operated to maneuver the boat 29 outwardly away from the water's edge. As the boat is maneuvered out, the force applied to the line as it passes through the slit 66 will be dictated by the speed of the craft and resistance applied by lure 25. The speed may thus be controlled to such an extent as the boat progresses outwardly or into position that the line will be drawn through the catch slit 66 in a yieldingly resistive manner to thus provide the desired action to the lure 25 and, in the event, a fish should strike, allow for additional play of the lines through the slit 35. This characteristic will be available until such time as the knot 81 is drawn into position abutting one side of the gripper to thus stop further deployment until such time as striking forces are applied to the lure with sufficient magnitude to effectuate flex of the finger 33 and consequent full release of the line from the slit 35.

In deployments where there has been no strike prior to engagement of the knot 81 with the stop surface of the gripper, the fisherman 41 may continue to manipulate the control 43 to control movement of the boat 29 as desired to continue to present the lure 25 to fish and various areas and locations within the range of the signals from the control device 43.

Once the desired location is reached the fisherman may jerk the line causing the relatively flexible release finger 33 to be hinged about its base away from the core to open the slit 35 and release the line 23. The boat may be maneuvered away and back to shore leaving the imitation or live bait, as the case may be, at the remote location to attract the fish. Once the line is released from the gripper 27, the fisherman may then maneuver the rod 21 in a conventional fashion, snapping the control device 43 off such rod to avoid any interference with play of the fish in a manner designed to achieve success. As will be appreciated by those skilled in the art, in some embodiments of the present invention the gripper may be mounted directly to the hull orienting the slit to extend in the general direction the line is to be drawn behind the boat.

The fish may then be played out to tire and be drawn to shore for retrieval by the fisherman's net or release back to the waters in a true catch and release program.

From the foregoing, it will be appreciated that the remote control fishing system of the present invention provides a practical, inexpensive means for deploying a fishing lure some distance from the fisherman and for holding such lure in the remote location with relatively modest force to avoid detection until such time as the fisherman has an opportunity to play the line from his or her rod in a conventional fashion.

I claim:

1. Remote controlled fishing system for controlling a fishing line deployed from a fish line deploying device and comprising:
fish line storage and deployment device for deploying a length of fish line from the deploying device to suspend a fish lure;
a remote controlled boat including a propulsion system and a steering system, and a control for controlling the propulsion system and steering system including a receiver and being responsive to receipt of selected signals to steer the boat;
an integral gripper including a resilient body formed with an open ended slit for receiving the fishing line, the body being operative to frictionally grip the line in the slit and to, upon a predetermined force being applied to the line, flex and release the line from the slit;
a mounting device on the boat and mounting the gripper therefrom; and
a remote control device including a transmitter operable to transmit the selected signals to the receiver whereby a fisherman may float the boat in a body of fishing water, attach the fish line to the gripper, and operate the control to transmit the selected signals to the receiver to operate the propulsion and steering systems to direct the boat to a remote location and, upon applying the predetermined force to the line, the body will operate to release the fishing line from the slit.

2. The remote control fishing system of claim 1 wherein:
the gripper is constructed of soft foam.

3. The remote control fishing system of claim 1 wherein:
the gripper is constructed of closed cell foam.

4. The remote control fishing system of claim 1 wherein:
the gripper is constructed of a foam material and includes a circular shaped core with a finger projecting generally spirally tangential from one side thereof and cooperating therewith to form the slit.

5. The remote control fishing system of claim 1 wherein:
the gripper is constructed of a soft material and the body includes a core and a finger projecting therefrom, the core and finger cooperating to form the slit and the connection between the finger and core being sufficiently flexible to exhibit a hinging effect for release of the line upon application of the predetermined force.

6. The remote controlled fishing system of claim 1 wherein:
the mount device includes an upstanding resilient wand mounting the gripper on the upper extremity thereof.

7. The remote control fishing system of claim 1 wherein:
the mounting device includes an upstanding base with a resilient wand projecting therefrom and mounting the grip and the upper extremity thereof.

8. The remote control fishing system of claim 1 wherein:
the wand is constructed of tempered steel.

9. The remote control fishing system of claim 1 wherein;
the gripper is constructed on one side of the body with a stop to be engaged by a knot formed in the line to stop play out thereof through the slit.

10. The remote control fishing system of claim 1 wherein:
the gripper is constructed of neoprene.

11. The remote control fishing system of claim 1 wherein:
the gripper is constructed to form the slit to curve inwardly from and an open edge and to then turn laterally to form a laterally projecting catch leg for receipt of the line.

12. A fishing line gripper for mounting on a remote controlled boat to carry a fishing line to a remote location and comprising:
an integral resilient body including a mount for mounting to the boat and formed with a slit for frictionally receiving the fishing line to grip such fish against sliding there through and operable upon application of a predetermined force downwardly on the line to open the slit and release the line.

13. The gripper of claim 12 wherein:
the body is constructed of closed cell foam.

14. The gripper of claim 12 wherein:
the body is constructed of neoprene.

15. The gripper of claim 12 that includes:
a body formed with a curved body edge and a finger projecting from the body and including a finger projecting from the body and formed with a finger edge cooperating with be body edge for form the slit.

16. The gripper of claim 15 wherein:
the body is formed with a catch slit projecting laterally from the first mentioned to form a blind end.

17. A method of fishing a remote location including:
selecting a fishing rod and a remote controlled boat;
selecting a gripper of the type including a soft body formed with an open ended slit constructed to frictionally engage and restrict deployment of fishing line from the rod;
mounting the gripper on the boat;
inserting the fishing line in the slit with the lure spaced from the gripper to be submerged in the water;
with a remote controller, controlling the boat to direct it to a remote location drawing the lure therewith;
in the event of a fish striking the lure and drawing the line from the slit, manipulating the fishing rod to play the fish on the lure independent of the gripper.

18. The method of claim 17 that includes:
selecting the gripper constructed of a soft material configured to, when a selected force is applied to the lure, draw the line through the slit; and
prior to the step of inserting the line in the slit, forming a knot in the line to, upon the selected force being applied to the line for a sufficient period of time to draw such line through the slit to engage the knot with one side of the gripper to limit further deployment thereof until such time as predetermined forces applied to the lure.

19. The remote control fishing system of claim 1 that includes:
a tether for releasably fastening the control to the person of a fisherman.

20. The remote control fishing system of claim 1 wherein:
the mounting device includes a compression fitting; and
a stem projecting upwardly therefrom to mount the gripper.
